(19) United States
(12) Patent Application Publication
(10) Pub. No.: US 2024/0053208 A1
(43) Pub. Date: Feb. 15, 2024

(54) APPARATUS FOR MEASURING TEMPERATURE USING DIAMOND NITROGEN-VACANCY CENTER SENSOR AND MANUFACTURING METHOD THEREFOR

(71) Applicant: KOREA RESEARCH INSTITUTE OF STANDARDS AND SCIENCE, Daejeon (KR)

(72) Inventors: Sangwon OH, Daejeon (KR); Jeong Hyun SHIM, Daejeon (KR); Seong-Joo LEE, Daejeon (KR); Kwang-Geol LEE, Seoul (KR); Juil HWANG, Seoul (KR); Seung Hun SONG, Chungju-si (KR); Ouk Jae LEE, Seoul (KR)

(21) Appl. No.: 18/011,919

(22) PCT Filed: Dec. 1, 2020
(86) PCT No.: PCT/KR2020/017360

§ 371 Date: Apr. 10, 2023

(30) Foreign Application Priority Data
Nov. 5, 2020 (KR) 10-2020-0146939

(51) Int. Cl. G01K 11/00

(52) U.S. Cl. CPC G01K 11/00

(57) ABSTRACT

The present disclosure relates to an apparatus for measuring temperature distribution in a wide area using a diamond nitrogen vacancy center sensor and a method for fabricating the same, and disclosed is a diamond nitrogen-vacancy center sensor capable of measuring a temperature in a wide area including: a plurality of diamond thin films that are provided at different positions on an insulator and are not connected to each other, and it will be possible to measure temperature distribution in a wide area using the same.

### TECHNICAL FIELD

Various embodiments relate to an apparatus for measuring temperature distribution in a wide area using a diamond nitrogen-vacancy center sensor and a method for fabricating the same.

### BACKGROUND ART

Diamond crystals are made up of carbon atoms, but when carbon atoms are replaced by other types of atoms, steady-state lattice defects occur. One of the defects is a nitrogen-vacancy center, in which one carbon atom is replaced by a nitrogen atom and the neighboring carbon atom is removed, leaving a blank space.

A diamond nitrogen-vacancy center (DNV) has an electron spin with a spin number (S) of 1, so the spin quantum may have three spin states (mₛ) which are+1, 0 and −1. In the absence of an external magnetic field in an axial direction of the nitrogen-vacancy center in diamond, the spin quanta in the +1 and −1 spin states (mₛ) overlap and exist at similar energy levels, but in the presence of an external magnetic field in the axial direction of the nitrogen-vacancy center in diamond, due to the Zeeman effect, the overlap of the spin quanta of the nitrogen-vacancy center in the +1 and −1 spin states (mₛ) disappears and they exist at different energy levels, so the spin quantum of the nitrogen-vacancy center can have two resonance frequencies corresponding to the spin transition between the spin state (mₛ=0) and the spin state (mₛ=+1) or between the spin state (mₛ=0) and the spin state (mₛ=−1). The difference between the two resonance frequencies is proportional to the magnitude of the external magnetic field.

When a laser of 532 nm wavelength is irradiated to the diamond nitrogen-vacancy center, the quantum in the spin state (mₛ=0) is excited and then returns to the ground state by emitting red light over 600 nm, and quanta in the spin state (mₛ=+1) and the spin state (mₛ=−1) are excited and return to the ground state while changing to a spin state (mₛ=0) without emitting red light. Therefore, the amount of fluorescence of the emitted red light may be proportional to the amount of spin quantum in the spin state (mₛ=0).

Applying two resonance frequencies corresponding to spin transitions to the diamond nitrogen-vacancy center causes a spin transition from a spin state (mₛ=0) to a spin state (mₛ=+1) or a spin state (mₛ=−1). As a result, the quantum amount of the spin state (mₛ=0) is reduced, and thus the amount of fluorescence of emitted red light is also reduced.

Therefore, by recording the change in fluorescence according to frequency while applying a microwave frequency that changes to the diamond nitrogen-vacancy center, an optically detected magnetic resonance (ODMR) spectrum with reduced fluorescence at the resonance frequency corresponding to each spin transition may be obtained. In this ODMR spectrum, the magnitude of the magnetic field applied to the diamond nitrogen-vacancy center may be determined based on the difference between the two resonance frequencies having reduced fluorescence.

The diamond nitrogen-vacancy center sensor is a sensor that is very sensitive to a temperature and a magnetic field, and is actively used to measure the fine spatial distribution of a temperature or a magnetic field. However, due to a very high temperature transfer coefficient (2150 W/(m*K)), when a bulk diamond is used, the temperature within the diamond becomes uniform, making it very difficult to measure the spatial distribution of a temperature. To solve this problem, a nanodiamond with a size of less than a micrometer is fixed to a sample by spin coating, and the like, and then the temperature of the nanodiamond is measured based on the cantilever. Alternatively, a diamond is fixed at the end of the optical fiber and the spatial distribution of a temperature is measured through the movement of the optical fiber.

### DISCLOSURE

### Technical Problem

It is very difficult for conventional methods for measuring the spatial distribution of a temperature to obtain an optimized temperature sensitivity, compared to a bulk diamond, because of a short spin-spin relaxation time (T2), a wide ODMR spectrum line width, difficulty in alignment with external magnetic fields and a disadvantage that spatial resolution is determined by a position of the nanodiamond. In addition, due to the characteristics of cantilever-based measurement, it takes a long time to measure a wide area, making it impractical.

Accordingly, the present disclosure aims to provide an apparatus for measuring a temperature using diamond nitrogen vacancy center sensor capable of measuring the spatial distribution of a temperature while solving the above-described disadvantages.

In addition, the present disclosure aims to provide a method for fabricating an apparatus for measuring a temperature using a diamond nitrogen vacancy center sensor capable of measuring the spatial distribution of a temperature.

The technical problems to be achieved in the present disclosure are not limited to the technical problems mentioned above, and other technical problems not mentioned can be clearly understood by those skilled in the art to which the present invention belongs from the description below.

### Technical Solution

According to various embodiments of the present disclosure, one embodiment is a wide-area temperature measuring apparatus based on a diamond nitrogen-vacancy center (DNV) sensor including: a diamond nitrogen-vacancy center sensor including a plurality of diamond thin films that are provided at different positions on an insulator and are not connected to each other; a frequency synthesizer for generating a reference signal; a first microwave generator having a frequency modulated based on the reference signal and generating a first microwave causing a first spin transition in which a spin quantum of the diamond nitrogen-vacancy center sensor transitions from a first spin state to a second spin state; a second microwave generator having a frequency modulated based on the reference signal and generating a second microwave causing a second spin transition in which a spin quantum of the diamond nitrogen-vacancy center sensor transitions from a first spin state to a third spin state; a laser irradiator for applying a laser to excite the spin quantum of the diamond nitrogen-vacancy center sensor from a ground state to an excited state; a power amplifier for combining and amplifying the first microwave and the second microwave to apply to the diamond nitrogen-vacancy center sensor; a detector for detecting a fluorescence signal output from each of the plurality of diamond thin films of the diamond nitrogen-vacancy center sensor; a lock-in amplifier outputting a result of comparing the reference signal with an output signal of the detector corresponding to each of the plurality of diamond thin films; and a controller determining a change in temperature at each of the diamond thin film locations based on a change in an output of the lock-in-amplifier.

According to various embodiments of the present disclosure, the wide-area temperature measuring apparatus may further include a reference detector for measuring power of the laser; and a differential circuit for outputting a difference between the output signal of the detector and the output signal of the reference detector, and the lock-in amplifier may output a result of comparing the reference signal with the output signal of the differential circuit corresponding to each of the plurality of diamond thin films.

According to various embodiments of the present disclosure, the wide-area temperature measuring apparatus may further include a permanent magnet or an electromagnet or a superconducting magnet for applying a constant static magnetic field to the diamond nitrogen-vacancy center sensor.

According to various embodiments of the present disclosure, the diamond nitrogen-vacancy center (DNV) sensor may further include an insulator thin film between the insulator and each of the plurality of diamond thin films.

According to various embodiments of the present disclosure, another embodiment is a wide-area temperature measuring apparatus based on a diamond nitrogen-vacancy center (DNV) sensor including: a diamond nitrogen-vacancy center sensor including a plurality of diamond thin films provided at different positions on an insulator and are not connected to each other; a frequency synthesizer for generating a reference signal; a first microwave generator having a frequency modulated based on the reference signal and generating a first microwave causing a first spin transition in which spin quantum of the diamond nitrogen-vacancy center sensor transitions from a first spin state to a second spin state; a second microwave generator having a frequency modulated based on the reference signal and generating a second microwave causing a second spin transition in which the spin quantum of the diamond nitrogen-vacancies sensor transitions from a first spin state to a third spin state; a laser irradiator for applying a laser to excite the spin quantum of the diamond nitrogen-vacancy center sensor from a ground state to an excited state; a power amplifier for combining and amplifying the first microwave and the second microwave to apply to the diamond nitrogen-vacancy center sensor; a camera for detecting a fluorescence signal output from each of the plurality of diamond thin films of the diamond nitrogen-vacancy center sensor; and a controller for determining a change in temperature at each of the diamond thin film locations based on an intensity of fluorescence output from the camera.

According to various embodiments of the present disclosure, the wide-area temperature measuring apparatus may further include: an objective lens focusing the fluorescence signal between the diamond nitrogen-vacancy center sensor and the camera.

According to various embodiments of the present disclosure, the wide-area temperature measuring apparatus may further include a permanent magnet or an electromagnet or a superconducting magnet for applying a constant static magnetic field to the diamond nitrogen-vacancy center sensor.

According to various embodiments of the present disclosure, the wide-area temperature measuring apparatus may further include an insulator thin film between the insulator and each of the plurality of diamond thin films.

The insulator and each of the plurality of diamond thin films may be bonded together by using a Van der waals force, or an optical adhesive, or by depositing an insulating material formed as a thin film on the diamond thin film and bonding the insulator thereto.

According to various embodiments of the present disclosure, still another embodiment is a method for fabricating a diamond nitrogen-vacancy center (DNV) sensor including: bonding a diamond thin film to an insulator substrate; applying photoresist on the diamond thin film; irradiating light by covering the photoresist with a mask for masking a position where the diamond thin film should exist; removing a remaining portion from the diamond thin film except for a portion where the photoresist applied by the masking remains; and removing the photoresist that remains.

According to various embodiments of the present disclosure, the method for fabricating a diamond nitrogen-vacancy center (DNV) sensor according to claim 12 may further include: removing a portion of the insulator from a portion from which the diamond thin film is removed through additional etching.

According to various embodiments of the present disclosure, the bonding the diamond thin film to the insulator substrate may include: bonding the insulator to the diamond thin film using Van der waals force or an optical adhesive, or depositing an insulating material formed as a thin film on the diamond thin film and bonding the insulator thereto.

According to various embodiments of the present disclosure, the depositing an insulating material formed as a thin film on the diamond thin film and bonding the insulator thereto may include: polishing a surface of the diamond by chemical mechanical polishing (CMP); depositing the thin film of the insulating material on the polished diamond surface; and bonding the insulator substrate to the diamond thin film using an insulating material bonding apparatus.

### Advantageous Effect

According to various embodiments, an apparatus fabricated according to the method proposed in the present disclosure may enable measuring of a spatial distribution of a temperature.

According to various embodiments, the apparatus manufactured according to the method proposed in the present disclosure may be used in the realization of control of gene expression and the metabolism of cancer cells through temperature control in a micro-space in the field of solid physics and biology, and may be applied to a cell-selective treatment of diseases.

According to various embodiments, the apparatus proposed in the present disclosure may measure a temperature distribution in each space within a cell, and using the result, may be used to develop a new drug through the study of the growth and characteristics of each component according to the temperature distribution within a cell, and the like.

According to various embodiments, the apparatus proposed by the present disclosure may measure thermal characteristics generated in each minute part of an ultra-large scale integrated circuit, and the result may be used to manufacture a more efficient next-generation ultra-large scale integrated circuit.

Effects obtainable in the present disclosure are not limited to the above-mentioned effects, and other effects not mentioned may be clearly understood by those skilled in the art to which the present disclosure belongs from the description below.

### DESCRIPTION OF DRAWINGS

FIG. 1 is a diagram showing an energy level diagram of a diamond nitrogen-vacancy center.

FIG. 2 is a view illustrating an example of an ODMR spectrum.

FIG. 3 is a view illustrating an ODMR spectrum measurement method using a cantilever.

FIG. 4 is a view illustrating an ODMR spectrum measurement method using a camera or a photo diode (PD).

FIG. 5 is a view illustrating an example of obtaining an ODMR spectrum by applying a microwave of which a frequency is modulated to a specific reference signal and extracting only the reference signal component from the signals generated by the photodetector by the lock-in amplifier (LIA) through phase comparison.

FIG. 6 is a view illustrating an example of an output of a lock-in amplifier.

FIGS. 7 and 8 are views illustrating examples of changes in the output of the lock-in amplifier according to a change in an external magnetic field.

FIG. 8 is a view illustrating an example of a change in the ODMR spectrum according to a temperature change.

FIG. 9 is a view schematically illustrating an apparatus for measuring a magnetic field and a temperature using a diamond nitrogen-vacancy center sensor.

FIG. 10 is a view showing various structures of test samples used to confirm the effectiveness of measuring the temperature change inside the diamond according to an injection of external heat.

FIG. 11 is a view showing a change in a temperature at a position for measuring a temperature when heat is applied to a heat injection passage material of each test sample shown in FIG. 10.

FIG. 12 is a view showing various structures of test samples used to confirm the possibility of measuring the spatial distribution of the internal temperature of the diamond according to an injection of external heat.

FIG. 13 is a view showing a difference in a temperature change at a plurality of positions for measuring a temperature when heat is applied to a heat injection passage material of each test sample shown in FIG. 12.

FIG. 14 is a view showing a process of manufacturing a diamond nitrogen-vacancy center sensor capable of measuring temperature distribution in a wide area.

FIG. 15 is a view illustrating the structure of a diamond nitrogen-vacancy center sensor manufactured according to the process of FIG. 14.

FIG. 16 is an example of a result of measuring the distribution of heat generated during driving of an ultra-large scale integrated circuit.

In connection with the description of the drawings, the same or similar reference numerals may be used for the same or similar components.

### MODE FOR INVENTION

Hereinafter, various embodiments will be described in detail with reference to the accompanying drawings.

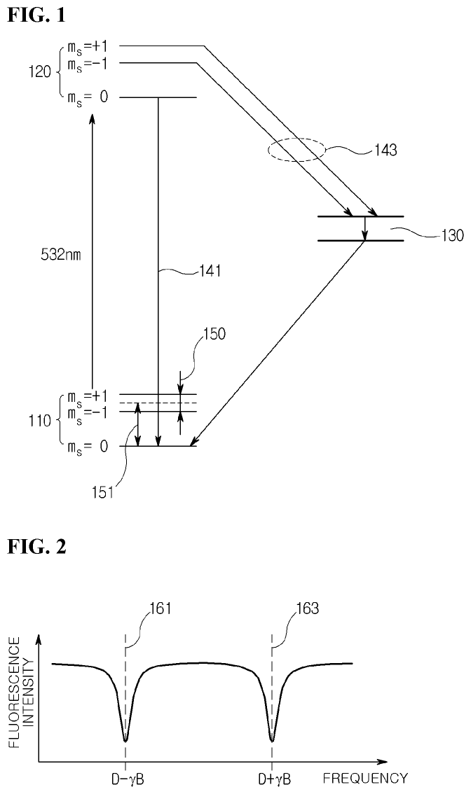

FIG. 1 is a diagram showing an energy level diagram of a diamond nitrogen-vacancy center.

Referring to FIG. 1, a diamond nitrogen-vacancy center has a ground state 110 having spin triplet which are three spin states: a spin state (mₛ=0), a spin state (mₛ=+1) and a spin state (mₛ=−1) symmetrical to each other. In the absence of a magnetic field, by spin-spin interaction, the spin state (mₛ=+1) and the spin state (mₛ=−1) are in the same energy state away from the spin state (mₛ=0) by a certain energy level. In the absence of a magnetic field, the energy level of the spin state (mₛ=0) is separated from the energy level of the spin state (mₛ=+1) and spin state (mₛ=−1) by approximately 2.87 GHz of energy 151.

When an external magnetic field is applied in the ground state 110, the energy of the spin state (mₛ=+1) and the spin state (mₛ=−1) having the same energy becomes to have an energy level 150 that is separated in proportion to the magnitude of the applied external magnetic field.

The spin quantum of the diamond nitrogen-vacancy center in the ground state 110 is excited and becomes in the excited state 120 when green light is irradiated. Green light may be light having a wavelength of 637 nm or less, preferably light having a wavelength of 532 nm. At this time, the spin quantum of the diamond nitrogen-vacancy center is excited while maintaining their spin state.

The spin quantum in the excited state 120 returns to the ground state 110 and most of the spin quanta in the spin state (mₛ=0) emit photons of red light (e.g., 600 nm or more to 900 nm or less) and return to the ground state 110 of a spin state (mₛ=0) 141, and certain portion thereof returns to the ground state 110 through a singlet 130 143. When a quantum passes through the singlet 130, the quantum returns to the ground state 110 without emitting red light.

Most of the spin quanta of the diamond-nitrogen vacancy center in the spin state (mₛ=+1) and in the spin state (mₛ=−1) of the excited state 120 return to the ground state 110 through the singlet 130, and the quanta return to the spin state (mₛ=0) rather than the original spin state (mₛ=±1). Therefore, when green light is irradiated, most of the spin quanta of the diamond nitrogen-vacancy center have a spin state (mₛ=0) after a certain time.

On the other hand, in a spin state (mₛ=0), when a resonance frequency corresponding to the energy difference between a spin state (mₛ=0) and a spin state (mₛ=+1) or between a spin state (mₛ=0) and a spin state (mₛ=−1) is applied, a spin transition from the spin state (mₛ=0) of the ground state 110 to the spin state (mₛ=+1) or spin state (mₛ=−1) is induced. Each resonance frequency (F) under an external magnetic field (B) is determined by F=D±ηB. Here, D may have a value of 2.87 GHz as a resonance frequency in the absence of a magnetic field, that is, a resonance frequency of zero field splitting, and n may have a value of 28 MHz/mT as a gyromagnetic ratio of an electron spin. Accordingly, in general, the magnitude of the magnetic field may be measured based on the difference (21B) between the two resonance frequencies. In addition, the temperature may be measured based on the fact that the resonance frequency in the absence of a magnetic field or the average value (D) of the two resonance frequencies has a temperature dependence of −74.2 kHz/° C.

When green light (e.g., light with a wavelength of 532 nm) is applied to the spin quantum of the ground state 110 of the diamond nitrogen-vacancy center, the spin quanta are excited to be in the excited state 120, and most of the spin quanta in the spin state (mₛ=+1) and in the spin state (mₛ=−1) of the excited state 120 return to the ground state 110 without emitting red light through 143 in FIG. 1, and most of the spin quanta in the spin state (mₛ=0) of the excited state 120 return to the ground state 110 while emitting red light over 600 nm along 141 of FIG. 1. At this time, the spin quantum in the spin state (mₛ=±1) is converted to the spin state (mₛ=0) and returns to the ground state 110, while maintaining the spin state (mₛ=0) of the spin quantum.

Therefore, if an optically-detected magnetic resonance (ODMR) spectrum that records the change in the amount of emitted light using a photodiode, while changing a wavelength of the applied microwave, is recorded, a portion with a low light intensity at two resonance frequencies corresponding to the energy difference between the spin state (mₛ=0) and the spin state (mₛ=+1), and the energy difference between the spin state (mₛ=0) and the spin state (mₛ=−1) may be observed.

FIG. 2 is a view illustrating an example of an ODMR spectrum.

Referring to FIG. 2, the ODMR spectrum that measured an amount of emitted light from the diamond nitrogen-vacancy center sensor using a photodiode, a CCD camera, or a CMOS camera shows a low amount of light measured at two resonance frequencies corresponding to the energy difference 163 between a spin state (mₛ=0) and a spin state (mₛ=+1), or the energy difference 161 between the spin state (mₛ=0) and the spin state (mₛ=−1). When a frequency other than the corresponding resonance frequency is applied, the spin state (mₛ=0) of the ground state 110 is not excited into a spin state (mₛ=+1) or a spin state (mₛ=−1), but a spin state (mₛ=0) remains. Further, when excited to the excited state 120 by green light, the spin quantum of the diamond nitrogen-vacancy center remaining in the spin state (mₛ=0) emits a photon of red light and returns to the ground state 110 along a path 141 of FIG. 1. To the contrary, when the corresponding resonance frequency is applied, the spin quantum in the spin state (mₛ=0) of the ground state 110 is converted to the spin state (mₛ=+1) or the spin state (mₛ=−1), and after being excited to the excited state 120 again by the green light, the spin quantum returns to the ground state 110 without emitting the photon of red light through a path 143 of FIG. 1, so that the amount of light measured by the photodiode is reduced. Therefore, the amount of light measured at the two resonance frequencies corresponding to the energy difference 163 between the spin state (mₛ=0) and the spin state (mₛ=+1) and the energy difference 161 between the spin state (mₛ=0) and the spin state (mₛ=−1) becomes low. In addition, the difference between these two frequency bands is proportional to the intensity of the magnetic field applied to the diamond nitrogen-vacancy center. Thus, the diamond nitrogen-vacancy center may be used to detect an existing magnetic field or a change in the magnetic field.

The ODMR spectrum measurement may be performed in two ways.

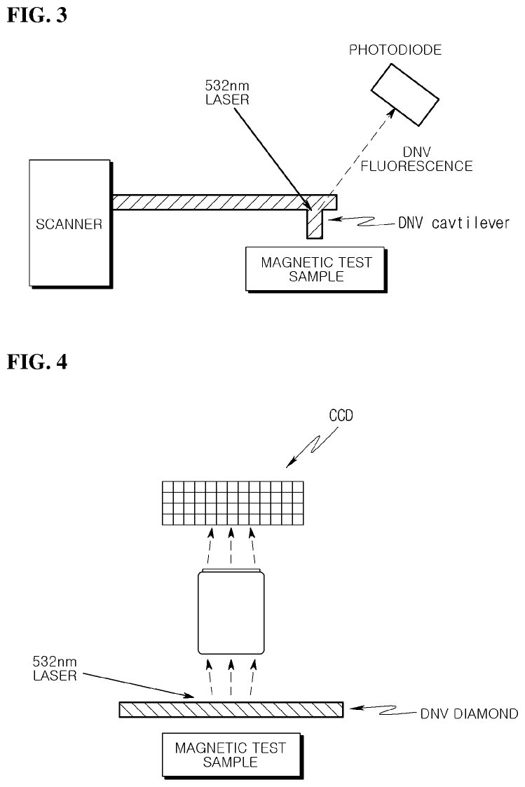

FIG. 3 is a view illustrating an ODMR spectrum measurement method using a cantilever, and FIG. 4 is a view illustrating an ODMR spectrum measurement method using a camera or a photo diode (PD).

The ODMR spectrum measurement using a cantilever shown in FIG. 3 measures a magnetic field in a narrow area with a magnetic field spatial resolution at a nanometer level, whereas the ODMR spectrum measurement using a camera or photodiode shown in FIG. 4 may quickly measure the magnetic field distribution over a wide area, through a magnetic field spatial resolution at a micrometer level.

In general, a lock-in amplifier (LIA), a high-performance charge-coupled camera (CCD), a high-performance sCMOS (scientific complementary metal-oxide-semiconductor), or a photodiode array to which a lock-in amplifier is combined (Lock-in Camera) and the like may be used to increase the magnetic field sensitivity.

When obtaining the ODMR spectrum, a frequency modulation technique may be used to improve the signal-to-noise ratio.

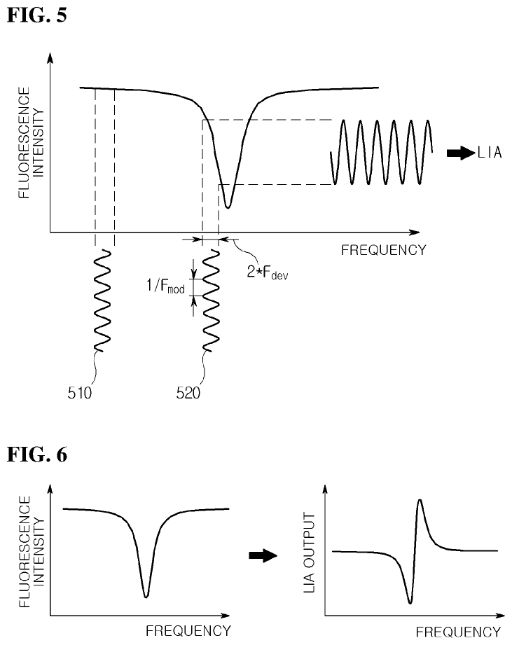

FIG. 5 is a view illustrating an example of obtaining an ODMR spectrum by applying a microwave of which a frequency is modulated to a specific reference signal and extracting only the reference signal component from the signals generated by the photodetector by the lock-in amplifier (LIA) through phase comparison, and FIG. 6 is a view illustrating an example of an output of a lock-in amplifier.

Referring to FIG. 5, when a microwave 510 obtained by frequency-modulating a reference signal to a frequency other than the resonance frequency is applied, the signal generated by the photodetector has almost no reference signal component because there is almost no inclination. On the other hand, when the microwave 520 of which the reference signal is frequency-modulated to the resonance frequency is applied, the inclination in the corresponding region is large, and thus, the reference signal component comes out of the signal detected by the photodetector. Accordingly, the reference signal may be detected by using a lock-in amplifier (LIA) capable of extracting the frequency of the reference signal. If frequency modulation shown in FIG. 5 is used, the intensity of the reference signal can be relatively increased compared to that of noise, and the signal-to-noise ratio may be improved by avoiding the influence of noise existing in a low frequency band of the signal. As shown in FIG. 5, the magnitude of the signal input to the lock-in-amplifier signal is proportional to the inclination of the ODMR spectrum, and an output of the lock-in-amplifier signal obtained through the frequency modulation method has a differential form of the original ODMR spectrum, and becomes a signal output as shown in FIG. 6. Accordingly, the resonance frequency may be detected by detecting a change in the output of the lock-in-amplifier shown in FIG. 6.

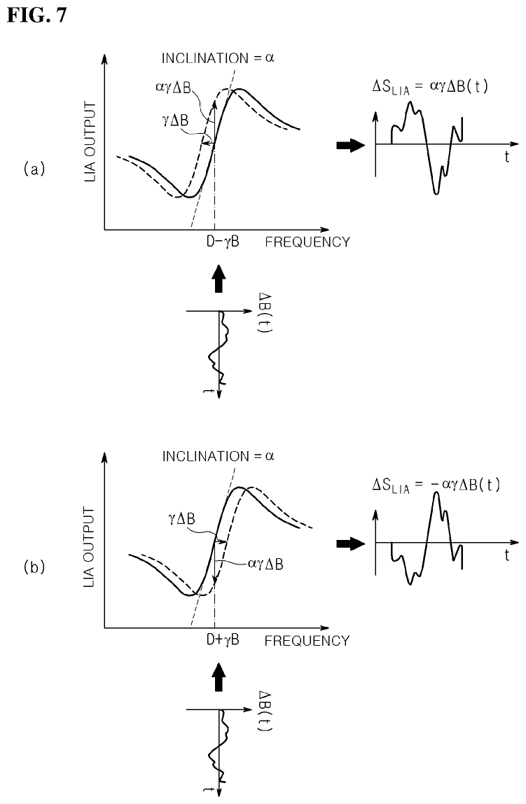

FIG. 7 is a view illustrating examples of changes in the output of the lock-in amplifier according to a change in an external magnetic field.

Referring to (a) of FIG. 7, when a center frequency of the frequency-modulated microwave is fixed to D-ηB which is a first resonance frequency in a situation where the spin quantum of the diamond nitrogen-vacancy center is spin-transitioned from the spin state (mₛ=0) to the spin state (mₛ=−1) and the external magnetic field changes by ΔB(t), the spectrum shifts toward a lower frequency and an output of the lock-in amplifier changes. This change (ΔS_{LIA}¹) is given as αηΔB(t).

Referring to (b) of FIG. 7, the center frequency of the frequency-modulated microwave is fixed to D+ηB which is a second resonance frequency in a situation where the spin quantum of diamond nitrogen-vacancy center is spin-transitioned from the spin state (mₛ=0) to the spin state (mₛ=+1) and the external magnetic field changes by ΔB, the spectrum shifts toward a higher frequency and the output of the lock-in amplifier changes. This change (ΔS_{LIA}²) is given as −αηΔB(t). Accordingly, it is possible to measure the change in the phase-inverted magnetic field.

On the other hand, if the ambient temperature changes, the average resonance frequency D also changes. Considering that the average resonance frequency changes by ΔD(t), the change in the lock-in amplifier output (ΔS_{LIA}¹) at the first resonance frequency may be α(−ΔD(t)+ηΔB(t)) and the change (ΔS_{LIA}²) in the output of the lock-in amplifier at the second resonance frequency may be −α(ΔD(t)+ηΔB(t)). That is, the change in the output of the lock-in amplifier at the first resonance frequency and the second resonance frequency may be expressed by mathematical formulas 1 and 2 below.

ΔS_{LIA}¹=α(−ΔD(t)+γΔB(t)) [mathematical formula 1]

ΔS_{LIA}²=−α(ΔD(t)+γΔB(t)) [mathematical formula 2]

In this way, the change in the external magnetic field (ΔB(t)) and the change in temperature (ΔD(t)) to be measured may be measured through the change (ΔS_{LIA}¹ or ΔS_{LIA}²) in the output signal of the lock-in amplifier. The magnitude of this signal may be proportional to the zero-crossing inclination (α) of the spectrum.

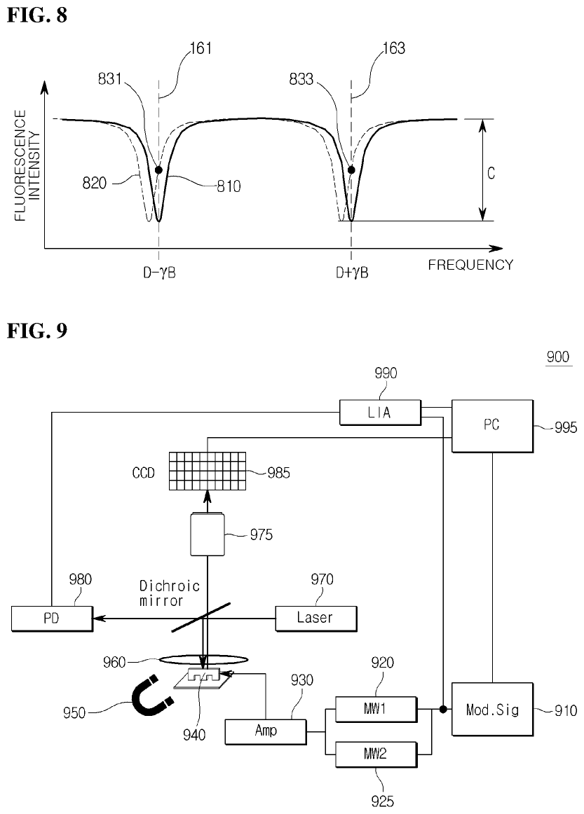

FIG. 8 is a view illustrating an example of a change in the ODMR spectrum according to a temperature change.

Referring to FIG. 8, when the temperature decreases by ΔD, the ODMR spectrum may move from the graph 810 to the graph 820 as shown in FIG. 8. Accordingly, if the first resonance frequency 161 and the second resonance frequency 162 in an initial setting state in which a temperature is not changed are being applied, fluorescence intensity increases from a lowest state to a size of a point 831 or a point 833.

In general, the fluorescence intensity may be approximated in a Lorentz form as in a mathematical formula 3 below.

$$I ( f ) = 1 - \frac{C}{{( \frac{v - f}{\frac{Δ v}{2}} )}^{2} + 1} \qquad [ mathematical formula 3 ]$$

Here, ν is the resonance frequency for a case of spin transition from a spin state (mₛ=0) to a spin state (mₛ=−1) or from a spin state (mₛ=0) to a spin state (mₛ=+1), and Δ_{ν} is the full width half maximum (FWHM) and represents a bandwidth between ½ points of the maximum value of the fluorescence intensity. C is a difference between a maximum value and a minimum value of the fluorescence intensity as shown in FIG. 8.

Moreover, at a frequency near the resonance frequency, a mathematical formula 3 may be approximately expressed as a mathematical formula 4.

$$I ( f ) \approx 1 - \frac{9}{8} C + \frac{4 \sqrt{3}}{4} \frac{C}{Δ v} \vert v - f \vert \qquad [ mathematical formula 4 ]$$

In order to measure a magnetic field or temperature based on the DNV sensor, a temperature or magnetic field may be measured by applying one selected among the first resonance frequency that causes a spin transition from the spin state (mₛ=0) to the spin state (mₛ=−1) and the second resonance frequency that causes a spin transition from the spin state (mₛ=0) to the spin state (mₛ=+1), and then, by measuring the intensity of light emitted from the lock-in amplifier or camera. However, when measuring it using one resonance frequency, it is difficult to find the exact value of the change when a temperature and a magnetic field change according to the time.

As an embodiment for overcoming this difficulty, a method using a double resonance frequency as shown in FIG. 9 may be proposed.

FIG. 9 is a view schematically illustrating an apparatus for measuring a magnetic field and a temperature using a diamond nitrogen-vacancy center sensor.

Referring to FIG. 9, an apparatus 900 for measuring a magnetic field or temperature using a diamond nitrogen-vacancy center sensor includes the diamond nitrogen-vacancy center sensor 940, a reference signal generator 910, a first microwave generator 920, and a second microwave generator 925, a power amplifier (PA) 930, a laser irradiation unit 970, a permanent magnet 950, a reference detector 980, a lock-in amplifier (LIA) 990, and a controller 995. In addition, the apparatus 900 may further include a test coil 960.

According to another embodiment, an objective lens 975 and a CCD camera 985 may be used instead of the lock-in amplifier 990 and the reference detector 980.

The reference signal generator 910 may generate a reference signal to be used for frequency modulation. According to the embodiment, the reference signal may be a frequency between 1 KHz and 100 KHz. The reference signal generator 910 may transmit the generated reference signal to the first microwave generator 920, the second microwave generator 925, and the lock-in amplifier 990. At this time, when the device 900 is set to measure a magnetic field, a reference signal transmitted to the first microwave generator 920 and a reference signal transmitted to the second microwave generator 925 have the same frequency and may be transmitted after phase inversion to have a phase difference by 180 degrees with each other. According to another embodiment, when the apparatus 900 is set to measure a temperature, the reference signal transmitted to the first microwave generator 920 and the reference signal transmitted to the second microwave generator 925 may have the same frequency and have the same phase. That is, the same signal may be transmitted. At this time, the reference signal transmitted to the first microwave generator 920 may also be transmitted to the lock-in amplifier 990 and may become a reference signal to be detected by the lock-in amplifier 990.

According to another embodiment, when the apparatus 900 is set to measure a magnetic field and a temperature at the same time, a reference signal transmitted to the first microwave generator 920 and a reference signal transmitted to the second microwave generator 925 have different frequencies. At this time, the first reference signal transmitted to the first microwave generator 920 and the second reference signal transmitted to the second microwave generator 925 are transmitted to the lock-in amplifier 990 and may become a reference signal to be detected by the lock-in amplifier 990. In this case, when it comes to the lock-in amplifier 990, two lock-in amplifiers may be provided thereto, and one lock-in amplifier may detect based on the first reference signal, and the other lock-in amplifier may perform detection based on the second reference signal.

The first microwave generator 920 and the second microwave generator 925 may generate a microwave obtained by modulating a microwave having a first resonance frequency causing a spin quantum of the diamond nitrogen-vacancy center sensor 940 to spin transition from a spin state (mₛ=0) to a spin state (mₛ=−1) and a microwave having a second resonance frequency causing a spin quantum of the diamond nitrogen-vacancy center sensor 940 to spin transition from a spin state (mₛ=0) to a spin state (mₛ=+1) based on a reference signal.

The power amplifier 930 may combine the microwave signals generated by the first microwave generator 920 and the second microwave generator 925, and then, amplify them, and input them to the diamond nitrogen-vacancy center sensor 940.

The laser irradiation unit 970 may irradiate a laser, that causes a spin quantum to be excited from the ground state 110 to the excited state 120, to the diamond nitrogen-vacancy center sensor 940. The permanent magnet 950 may apply a constant static magnetic field to the diamond nitrogen-vacancy center sensor 940. Precise frequencies of microwave signals generated by the first microwave generator 920 and the second microwave generator 925 may be determined based on the static magnetic field applied by the permanent magnet 950. According to the embodiment, an electromagnet or a superconducting magnet may be used instead of the permanent magnet 950.

With regard to the spin quantum of the diamond nitrogen-vacancy center sensor 940, two spin transitions are caused by input microwave signals generated in the first microwave generator 920 and the second microwave generator 925, and after being excited to the excited state 120 by the laser irradiation unit 970 and returning to the ground state 110, the spin quantum may generate fluorescence.

The lock-in amplifier 990 may receive the fluorescence generated from the diamond nitrogen-vacancy center sensor 940 and output a result of comparison compared with the reference signal. According to the embodiment, two lock-in amplifiers 990 may be provided to output a result of comparison with the first reference signal and a result of comparison with the second reference signal.

According to the embodiment, the apparatus 900 may further include the reference detector 980 and a differential circuit in order to cancel the noise of the laser in the lock-in amplifier 990.

The reference detector 980 may measure the power of the laser input to the diamond nitrogen-vacancy center sensor 940 and transmit it to the differential circuit.

The differential circuit performs a CNR (common noise rejection) function for obtaining only a differential signal that is a difference between the laser measurement signal from the reference detector 980 and the output signal of the diamond nitrogen-vacancy center sensor 940, thereby canceling the noise caused by the laser.

The apparatus 900 may further include a test coil 960 that applies a calibrated test magnetic field to measure the magnetic field sensitivity of the apparatus.

The controller 995 may control the magnetic field measurement and/or the temperature measurement by the apparatus 900. The controller 995 may set whether the apparatus 900 measures a magnetic field, a temperature, or a magnetic field and a temperature. According to the embodiment, the controller 995 may set whether to measure a magnetic field and/or a temperature based on an operator's input. The reference signal generator 910 generates reference signals whose phases are inverted to each other for measuring a magnetic field based on the setting of the controller 995, or generates reference signals having the same phase with each other for measuring a temperature, or generates reference signals having different frequencies for measuring a magnetic field and a temperature, based on settings of the controller 995.

Also, the controller 995 may set a microwave frequency to be generated by the first microwave generator 920 and the second microwave generator 925 and provide them to the first microwave generator 920 and the second microwave generator 925. According to the embodiment, the controller 995 may set a microwave frequency to be generated based on an operator's input, or automatically select and set a pair having the most similar zero-crossing inclination among six frequency pairs available based on a result of the measurement.

Also, the controller 995 may set an amplitude (F_{dev}) of the reference signal and power (P_{MW}) of the microwave being injected into the diamond nitrogen-vacancy center sensor 940 which are determined by the power amplifier 930. Since the amplitude of the reference signal (F_{dev}) and the power of the microwave (P_{MW}) affect the zero-crossing inclination (α), the zero-crossing inclination (α) at a frequency corresponding to the two spin transitions should be the same in order to maximize the offsetting effect of the temperature changes or the magnetic field changes. Accordingly, the controller 995 may set the amplitude (F_{dev}) of the reference signal and the power (P_{MW}) of the microwave so that the zero-crossing inclinations (α) at a frequency corresponding to the two spin transitions can become as identical as possible. Also, according to the embodiment, the controller 995 may determine the amplitude (F_{dev}) of the reference signal so that the lock-in amplifier output has a shape shown in FIG. 6. When the amplitude (F_{dev}) of the reference signal is small, referring to FIG. 5, there may be a maximum point and a minimum point in a certain frequency range. Accordingly, the maximum and minimum points of the output of the lock-in amplifier of FIG. 6 may appear the same within a certain range. Accordingly, the controller 995 may determine the amplitude (F_{dev}) of the reference signal from which a shape of an output of the lock-in amplifier shown in FIG. 6 may be obtained through repeated experiments.

Also, the controller 995 may collect output data from the lock-in amplifier 990 and measure a change in temperature and/or a change in a magnetic field using the results. When a difference of 180 degrees exists in phases of microwaves generated by the first microwave generator 920 and the second microwave generator 925 in the apparatus of FIG. 9, the value of the mathematical formula 1 minus the value of the mathematical formula 2 becomes the output value of the lock-in amplifier, which changes only according to the change in the magnetic field regardless of the change in a temperature, and as a result, it becomes possible to precisely measure the magnetic field.

ΔS_{LIA}¹⁻²=2αγΔB(t) [mathematical formula 5]

On the other hand, when the phases of the microwaves generated by the first microwave generator 920 and the second microwave generator 925 are set to be the same, the output value of the lock-in amplifier obtained by adding the values of mathematical formulas 1 and 2 changes only according to the change in a temperature as in the following mathematical formula 6, regardless of the change in the magnetic field, and as a result, it becomes possible to precisely measure the temperature.

ΔS_{LIA}¹⁺²=−2αΔD(t) [mathematical formula 6]

Meanwhile, according to another embodiment, a CCD camera or a CMOS camera may be used instead of the lock-in amplifier to measure the temperature based on the measured amount of light.

When the two frequencies f1 and f2 are applied by the apparatus shown in FIG. 9, the mathematical formula 4 may be expressed as the mathematical formula 7.

$$I ( {f}_{1} {f}_{2} ) \approx 1 - \frac{9}{8} C + \frac{4 \sqrt{3}}{4} \frac{C}{Δ v} ( \vert {v}_{-} - f 1 \vert + \vert {v}_{+} - f 2 \vert ) \qquad [ mathematical formula 7 ]$$

As shown in FIG. 8, as the resonance frequency (ν) may change with a temperature and a magnetic field, the resonance frequency may be expressed as ν.(t)=(D(t)−γB(t), ν₊(t)=D(t)+γB(t), and f1 and f2 correspond to the resonance frequencies at an initial setting before the temperature and magnetic field change, and so, may be expressed as ƒ1=D−γB, ƒ2=D+γB. When this is applied to a mathematical formula 5, it may be expressed as a function dependent only on the change in temperature as shown in a mathematical formula 8 below.

$$I ( {f}_{1} {f}_{2} ) = 1 - \frac{9}{8} C + \frac{4 \sqrt{3}}{4} \frac{C}{Δ v} ( 2 Δ D ( t ) ) \qquad [ mathematical formula 8 ]$$

Therefore, it is possible to precisely measure the temperature even by measuring the amount of light output from the diamond nitrogen-vacancy center sensor using a camera.

The diamond nitrogen-vacancy center sensor used in FIG. 9 is a sensor that is very sensitive to a temperature and a magnetic field, and may be used where a fine spatial distribution of a temperature is measured. However, due to a very high temperature transfer coefficient (2150 W/(m*K)), when a bulk diamond is used, the temperature within the diamond becomes uniform, making it very difficult to measure the spatial distribution of a temperature. To solve this problem, measures for measuring spatial distribution of a temperature have been proposed such as measurement after fixing a nanodiamond with a size of less than a micrometer to a sample by spin coating, and the like, and then measuring a temperature of a place where the nanodiamond is located based on a cantilever, or measurement after fixing a diamond at an end of an optical fiber and moving the optical fiber to measure spatial distribution of a temperature. However, these methods have the disadvantage that the spatial resolution is determined by a position of the nanodiamond, short spin-spin relaxation time (T2), a wide ODMR spectral linewidth, difficulty of alignment with an external magnetic field and the like, so it is very difficult to get optimized temperature sensitivity, compared to a bulk diamond. In addition, due to characteristics of cantilever-based measurement that can only measure a temperature in a narrow area, it takes a long time to measure a wide area, making it impractical.

In order to solve this problem, the present disclosure suggests an apparatus and method for measuring precise spatial distribution of a temperature based on a diamond nitrogen-vacancy center sensor manufactured by fixing a diamond thin film on an insulator and then removing the connection of the diamond thin film through etching.

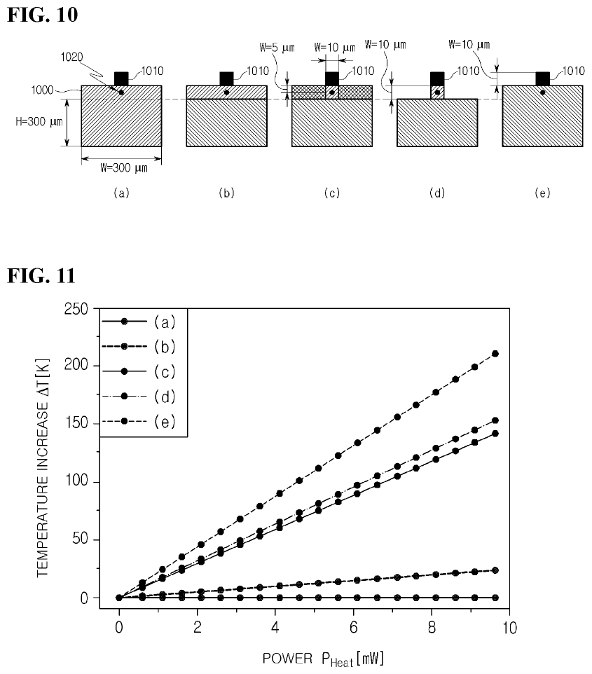

FIG. 10 is a view showing various structures of test samples used to confirm the effectiveness of measuring the temperature change inside the diamond according to an injection of external heat.

Referring to FIG. 10, a test sample 1000 may have a length of 300 μm and a height of 310 μm. A heat injection passage material 1010 may be placed at a center of the test sample 1000. The heat injection passage material 1010 may have a height of 10 μm.

In addition, a point 5 μm below the heat injection passage material 1010 may be a position for measuring a temperature 1020.

A test sample in (α) is a bulk diamond composed entirely of diamonds containing DNV. A test sample in (b) is composed of quartz, which is an insulator, with a height of up to 300 μm from the bottom, and a diamond thin film with a height of 10 μm may be placed on it. At this time, the diamond thin film may be fixed on the insulator by using a Van der waals force or by using an optical glue.

According to another embodiment, the diamond thin film may be fixed on the insulator by depositing an insulating material as a thin film on the diamond thin film and then bonding the insulating material. According to the embodiment, after polishing a surface of the diamond thin film to be bonded to have a very low roughness (e.g., root mean square (rms) roughness level of 0.5 nm) by chemical mechanical polishing (CMP), and the like, and depositing a thin (for example, about 30 nm) film made of an insulating material on the polished diamond surface, it is possible to bond the insulator to the diamond thin film using an insulating material bonding device. In this case, the insulating material may be silicon dioxide (SiO₂) or yttrium oxide (Y₂O₃).

A test sample in (c) has a structure in which the test sample is formed of quartz with a height of up to 300 μm from a bottom thereof, a diamond filler thin film is positioned below the heat injection passage material 1010, and an oxide film is formed on the quartz around the diamond filler thin film. A test sample in (d) has a structure in which the test sample is formed of quartz by a height of up to 300 μm from a bottom thereof, and the diamond filler thin film is located only under the heat injection passage material 1010. In the structures of (c) and (d), the diamond filler thin film may be manufactured through a photoresist (PR) coating and etching. A test sample in (e) has a structure composed entirely of quartz.

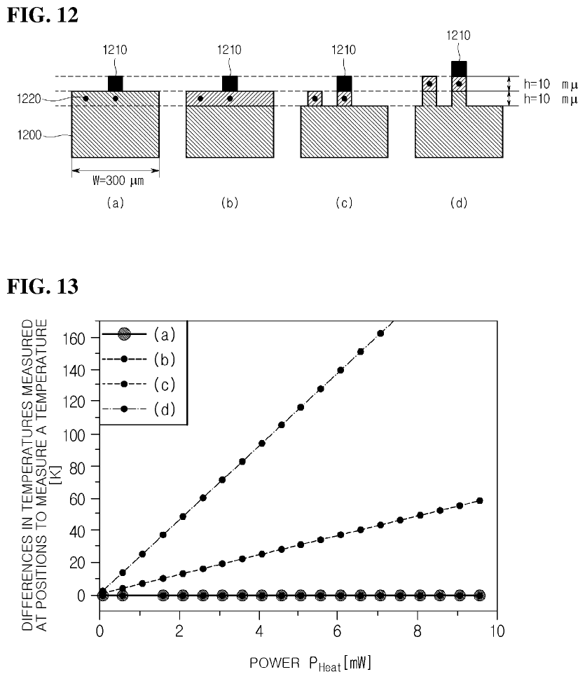

FIG. 11 is a view showing a change in a temperature at a position for measuring a temperature 1020 when heat is applied to a heat injection passage material of each test sample shown in FIG. 10.

Referring to FIG. 11, in the structure of (d) in FIG. 10, it can be seen that an internal temperature changes the most according to a change of an external temperature. Therefore, it may be determined that the use of the structure of (d) in FIG. 10 is the most effective in manufacturing a diamond nitrogen-vacancy center sensor for measuring temperature distribution in a wide area.

FIG. 12 is a view showing various structures of test samples used to confirm the possibility of measuring the spatial distribution of the internal temperature of the diamond according to an injection of external heat.

Referring to FIG. 12, the test sample 1200 may have a length of 300 μm. The heat injection passage material 1210 may be placed in a center of the test sample 1200. The heat injection passage material 1210 may have a height of 10 μm.

In addition, there may be a plurality of positions for measuring a temperature 1220 along a length of the test sample at a point 5 μm below the heat injection passage material 1210. The plurality of positions for measuring a temperature 1220 in each test sample 1200 may be located at the same position with respect to the heat injection passage material 1210.

The test sample in (a) is a bulk diamond composed entirely of diamonds containing DNV. The test sample of (b) may be composed of quartz, which is an insulator, with a height of up to 300 μm from the bottom, and may be composed of a diamond thin film with a height of 10 μm thereupon. At this time, the diamond thin film may be fixed on the insulator by using a Van der waals force, by using an optical glue, or by depositing an insulating material as a thin film thereon and then bonding the insulator thereto. A test sample in (c) has a structure in which a bottom of the test sample is made of quartz with a height of up to 300 μm, and the diamond filler thin film is positioned only at the plurality of positions for measuring a temperature 1220 thereon. A test sample in (d) is composed of quartz with a height of up to 300 μm from the bottom, and a 10 μm high insulator (quartz) filler thin film and a 10 μm high diamond filler thin film are positioned thereupon corresponding to the plurality of positions for measuring a temperature 1220. In the structures of (c) and (d), the filler thin film may be produced by photoresist (PR) coating and etching.

FIG. 13 is a view showing a difference in a temperature change at a plurality of positions for measuring a temperature when heat is applied to a heat injection passage material of each test sample shown in FIG. 12.

Referring to FIG. 13, in the structure of (α) or (b) of FIG. 12, it can be seen that there is almost no difference in temperatures measured at the plurality of positions for measuring a temperature. This may be because of rapid heat dissipation of diamonds due to their high thermal conductivity. Therefore, it may be judged that it is difficult to measure the temperature distribution in a wide area with the structure of (α) or (b). It can be seen that in the structure of (c) in which the diamond filler thin film is provided on an insulator and (d) in which the insulator filler thin film and the diamond filler thin film are used on the insulator, there are differences in temperatures measured at the plurality of positions for measuring a temperature. Therefore, it can be seen that the temperature distribution in a wide area may be measured using the structure of (c) or (d) of FIG. 12.

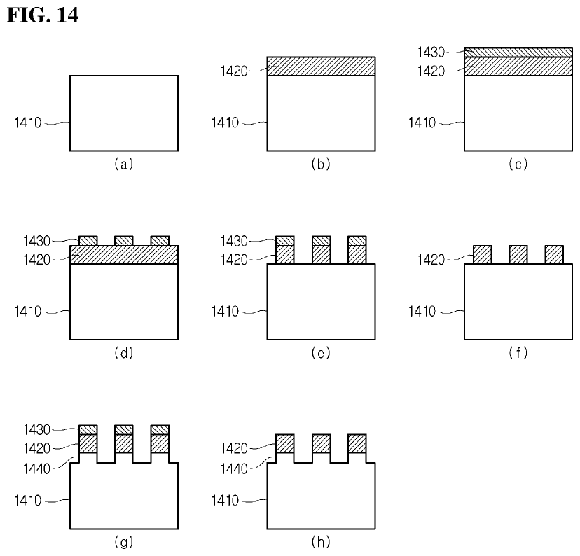

FIG. 14 is a view showing a process of manufacturing a diamond nitrogen-vacancy center sensor capable of measuring temperature distribution in a wide area.

Referring to FIG. 14, a substrate may be formed using an insulator 1410 such as quartz in (α). In (b), the diamond thin film 1420 including nitrogen vacancies may be bonded upon the insulator 1410. The diamond thin film may be fixed on the insulator 1410 by using a Van der waals force, by using an optical glue, or by depositing an insulating material as a thin film on the diamond thin film 1420 and then bonding the insulator 1410 thereto. In (c), the photoresist 1430 may be coated on the diamond thin film 1420, and a mask may be placed on the photoresist 1430 so that the diamond thin film 1420 remains only at a position where the temperature is to be measured. According to another embodiment, a hard mask may be directly covered instead of the photoresist and the mask. In (d), it is possible that the photoresist 1430 may be left only at a position where the temperature is to be measured through photosensitization. A portion that is not masked by the photoresist 1430 may be cut out by performing etching in (e). By removing the photoresist 1430 in (f), it is possible to configure the diamond nitrogen vacancy center sensor of the structure (c) of FIG. 12. According to another embodiment, as in (g), it is possible to cut out a portion of the insulator 1410 from a portion not masked by the photoresist 1430 through additional etching. By removing the photoresist 1430 in (h), it is possible to configure the diamond nitrogen vacancy center sensor of the structure (d) of FIG. 12.

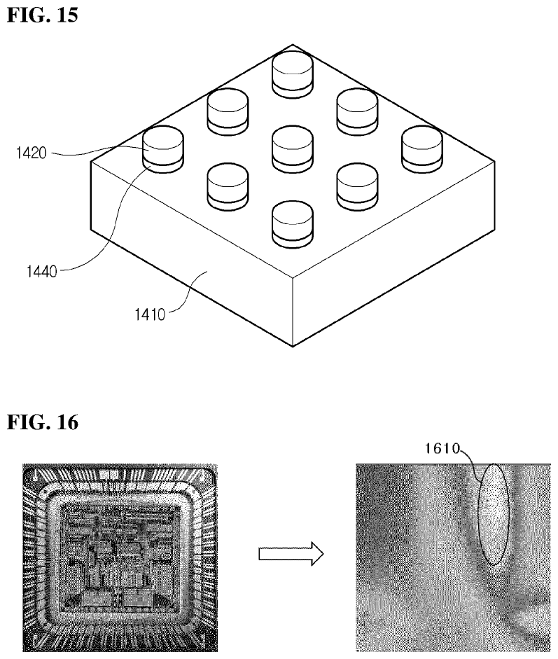

FIG. 15 is a view illustrating the structure of a diamond nitrogen-vacancy center sensor manufactured according to the process of FIG. 14.

FIG. 15 is the diamond nitrogen-vacancy center sensor having a structure of (d) of FIG. 12.

When measuring a temperature of a wide area using the apparatus shown in FIG. 9 having the diamond nitrogen vacancy center sensor in the structure shown in FIG. 15, a temperature at each position may be measured without heat exchange occurring between the positions for measuring a temperature as shown in FIG. 13.

For example, the distribution of heat generated during driving of the ultra-large scale integrated circuit may be measured using the apparatus shown in FIG. 9.

FIG. 16 is an example of a result of measuring the distribution of heat generated during driving of an ultra-large scale integrated circuit.

As illustrated in FIG. 16, it is possible to derive a specific region 1610 in which a lot of heat is generated in the ultra-large scale integrated circuit through this measurement, and that may contribute to analysis and solution of the cause of the huge heat generation in the corresponding region.

1. A wide-area temperature measuring apparatus based on a diamond nitrogen-vacancy center (DNV) sensor, comprising:
a diamond nitrogen-vacancy center sensor comprising a plurality of diamond thin films that are provided at different positions on an insulator and are not connected to each other;
a frequency synthesizer for generating a reference signal;
a first microwave generator having a frequency modulated based on the reference signal and generating a first microwave causing a first spin transition in which a spin quantum of the diamond nitrogen-vacancy center sensor transitions from a first spin state to a second spin state;
a second microwave generator having a frequency modulated based on the reference signal and generating a second microwave causing a second spin transition in which the spin quantum of the diamond nitrogen-vacancy center sensor transitions from a first spin state to a third spin state;
a laser irradiator for applying a laser to excite the spin quantum of the diamond nitrogen-vacancy center sensor from a ground state to an excited state;
a power amplifier for combining and amplifying the first microwave and the second microwave to apply to the diamond nitrogen-vacancy center sensor;
a detector for detecting a fluorescence signal output from each of the plurality of diamond thin films of the diamond nitrogen-vacancy center sensor;
a lock-in amplifier outputting a result of comparing the reference signal with an output signal of the detector corresponding to each of the plurality of diamond thin films; and
a controller determining a change in temperature at each of the diamond thin film locations based on a change in an output of the lock-in-amplifier.

2. The wide-area temperature measuring apparatus of claim 1, further comprising:
a reference detector for measuring power of the laser; and
a differential circuit for outputting a difference between the output signal of the detector and the output signal of the reference detector, and
wherein the lock-in amplifier outputs a result of comparing the reference signal with the output signal of the differential circuit corresponding to each of the plurality of diamond thin films.

3. The wide-area temperature measuring apparatus of claim 1, further comprising:
a permanent magnet or an electromagnet or a superconducting magnet for applying a constant static magnetic field to the diamond nitrogen-vacancy center (DNV) sensor.

4. The wide-area temperature measuring apparatus of claim 1, further comprising:
an insulator thin film between the insulator and each of the plurality of diamond thin films.

5. A wide-area temperature measuring apparatus based on a diamond nitrogen-vacancy center (DNV) sensor comprising:
a diamond nitrogen-vacancy center sensor comprising a plurality of diamond thin films provided at different positions on an insulator and are not connected to each other;
a frequency synthesizer for generating a reference signal;
a first microwave generator having a frequency modulated based on the reference signal and generating a first microwave causing a first spin transition in which a spin quantum of the diamond nitrogen-vacancy center sensor transitions from a first spin state to a second spin state;
a second microwave generator having a frequency modulated based on the reference signal and generating a second microwave causing a second spin transition in which the spin quantum of the diamond nitrogen-vacancies sensor transitions from a first spin state to a third spin state;
a laser irradiator for applying a laser to excite the spin quantum of the diamond nitrogen-vacancy center sensor from a ground state to an excited state;
a power amplifier for combining and amplifying the first microwave and the second microwave to apply to the diamond nitrogen-vacancy center sensor;
a camera for detecting a fluorescence signal output from each of the plurality of diamond thin films of the diamond nitrogen-vacancy center sensor; and
a controller for determining a change in temperature at each of the diamond thin film locations based on an intensity of fluorescence output from the camera.

6. The wide-area temperature measuring apparatus of claim 5, further comprising:
an objective lens focusing the fluorescence signal between the diamond nitrogen-vacancy center sensor and the camera.

7. The wide-area temperature measuring apparatus of claim 5, further comprising:
a permanent magnet or an electromagnet or a superconducting magnet for applying a constant static magnetic field to the diamond nitrogen-vacancy center sensor.

8. The wide-area temperature measuring apparatus of claim 5, further comprising:
an insulator thin film between the insulator and each of the plurality of diamond thin films.

9. A diamond nitrogen-vacancy center (DNV) sensor capable of performing wide-area temperature measurement comprising:
an insulator; and
a plurality of diamond thin films provided at different positions on the insulator and not connected to each other.

10. The diamond nitrogen-vacancy center (DNV) sensor of claim 9, further comprising:
an insulator thin film provided between the insulator and each of the plurality of diamond thin films.

11. The diamond nitrogen-vacancy center (DNV) sensor of claim 9 or 10,
wherein the insulator and each of the plurality of diamond thin films are bonded together by using a Van der waals force, or an optical adhesive, or by depositing an insulating material formed as a thin film on the diamond thin film and bonding the insulator thereto.

12. A method for fabricating a diamond nitrogen-vacancy center (DNV) sensor, comprising:
bonding a diamond thin film to an insulator substrate;
applying photoresist on the diamond thin film;
irradiating light by covering the photoresist with a mask for masking a position where the diamond thin film should exist;
removing a remaining portion from the diamond thin film except for a portion where the photoresist applied by the masking remains; and
removing the photoresist that remains.

13. The method for fabricating a diamond nitrogen-vacancy center (DNV) sensor of claim 12, further comprising:
removing a portion of the insulator from a portion from which the diamond thin film is removed through additional etching.

14. The method for fabricating a diamond nitrogen-vacancy center (DNV) sensor of claim 12 or 13,
wherein the bonding the diamond thin film to the insulator substrate comprises:
bonding the insulator to the diamond thin film using Van der waals force or an optical adhesive, or depositing an insulating material formed as a thin film on the diamond thin film and bonding the insulator thereto.

15. The method for fabricating a diamond nitrogen-vacancy center (DNV) sensor of claim 14,
wherein the depositing an insulating material formed as a thin film on the diamond thin film and bonding the insulator thereto comprises:
polishing a surface of the diamond by chemical mechanical polishing (CMP);
depositing the thin film of the insulating material on the polished diamond surface; and
bonding the insulator substrate to the diamond thin film using an insulating material bonding apparatus.
